(19) United States
(12) Patent Application Publication
(10) Pub. No.: US 2024/0017994 A1
(43) Pub. Date: Jan. 18, 2024

(54) METHOD FOR MINIMIZING NITROGEN OXIDE EMISSIONS OF A STEAM REFORMING PLANT AND STEAM REFORMING PLANT THEREFOR

(71) Applicants: thyssenkrupp Industrial Solutions AG, Essen (DE); thyssenkrupp AG, Essen (DE)

(72) Inventor: Oliver MEISSNER, Gladbeck (DE)

(73) Assignees: thyssenkrupp Industrial Solutions AG, Essen (DE); thyssenkrupp AG, Essen (DE)

(21) Appl. No.: 18/038,926

(22) PCT Filed: Nov. 16, 2021
(86) PCT No.: PCT/EP2021/081763

§ 371 Date: May 25, 2023

(30) Foreign Application Priority Data
Nov. 27, 2020 (DE) 10 2020 214 918.6

(51) Int. Cl. C01B 3/38

(52) U.S. Cl. CPC C01B 3/38; C01B 2203/0811; C01B 2203/0465; C01B 2203/0233

(57) ABSTRACT

The present disclosure relates to a process for feeding firing units of a steam reformer with a second fuel gas and a first flue gas, wherein the first flue gas is generated in an external combustion chamber arranged outside the steam reformer and upstream of the steam reformer by combustion of a first fuel gas with air and, together with the second fuel gas, introduced into the firing units of the steam reformer for firing, wherein the first flue gas has a residual oxygen content sufficient for the firing. The disclosure also relates to a steam reforming plant for performing such a process.

### CROSS REFERENCE TO RELATED APPLICATIONS

This application is a U.S. National Stage Entry of International Patent Application Serial Number PCT/EP2021/081763, filed Nov. 16, 2021, which claims priority to German Patent Application No. DE 10 2020 214 918.6, filed Nov. 27, 2020, the entire contents of all of which are incorporated herein by reference.

### FIELD

The present disclosure generally relates to a process for feeding firing units of a steam reformer with a second fuel gas and a first flue gas. The disclosure further relates to a steam reforming plant for performing this process.

### BACKGROUND

In light of the demand for hydrogen which is increasing worldwide, production capacities are being continuously expanded and processes for hydrogen production optimized in terms of efficiency. An efficient and therefore also widely used method for hydrogen production is steam reforming, wherein hydrogen is produced from hydrocarbons such as for example from natural gas, naphtha (crude oil, petroleum), LPG, hydrogen-rich gases such as refinery offgases, biomass or crude oil.

Steam reforming is typically embedded in the following process chain:

Often arranged upstream of the steam reforming is an input preparation which comprises for example a compression or evaporation or preheating of the input material. This is often followed by a two-stage material desulfurization in which organic sulfur compounds but also olefins present in the input material are hydrogenated in a hydrogenation unit. The sulfur now in the form of H₂S is subsequently absorbed on zinc oxide for example.

Input material preparation is followed by addition of, for example, the entirety of the process steam amount required for the subsequent catalytic steps. The addition is carried out in a specific molar ratio. The ratio is formed from the organic carbon present in the input material stream and the process steam flow rate.

For reasons of minimizing the input material and fuel consumption and minimizing the size of the steam reformer a prereforming which effects conversion of heavy hydrocarbons into methane, hydrogen, carbon monoxide and carbon dioxide at about 450° C. to 540° C. may be performed in an adiabatic reactor prior to the actual steam reforming.

The actual steam reforming to obtain hydrogen in a steam reformer is carried out at about 500° C. to 930° C. and occurs in the course of an endothermic reaction of hydrocarbon, for example methane, and steam:

CH₄+H₂O⇔CO+3H₂

The energy for the endothermic reaction is provided by firing in the steam reformer.

For saturated hydrocarbons and in general form the following applies:

CₙHₘ+nH₂O⇔nCO+(m/2+n)H

To enhance the hydrogen yield there may follow, and in the case of a plant for hydrogen production there often follows, a so-called water gas shift reaction in which carbon monoxide and water (process steam) are reacted to afford carbon dioxide and hydrogen:

CO+H₂O⇔CO₂+H₂

Finally, the synthesis gas exiting the steam reformer is cooled to a temperature suitable for the pressure swing adsorption plant. In the pressure swing adsorption plant impurities such as CO, CO₂, H₂O, N₂ and CH₄ are efficiently separated to obtain high purity hydrogen.

A particular problem in the case of steam reforming is that not inconsiderable amounts of nitrogen oxides (NOₓ), in particular thermal NOₓ, are generated since the formation of thermal NOₓ, increases disproportionately with the flame temperature and the temperatures occurring in the firing space of the steam reformer are relatively high. One way to minimize effective NOₓ generation is that of incorporating a cost- and resource-intensive denoxing, in particular a catalytic denoxing plant, to reduce the nitrogen oxide emission to an acceptable level.

Thus a need exists to provide a process for feeding firing units of a steam reformer by which the formation of thermal nitrogen oxides is reduced to such an extent that the denoxing plant can be made markedly smaller and less costly and can be operated in a manner that is more resource-efficient.

### BRIEF DESCRIPTION OF THE FIGURES

FIG. 1 shows a schematic representation of a steam reforming plant for performing the process of the present disclosure.

### DETAILED DESCRIPTION

Although certain example methods and apparatus have been described herein, the scope of coverage of this patent is not limited thereto. On the contrary, this patent covers all methods, apparatus, and articles of manufacture fairly falling within the scope of the appended claims either literally or under the doctrine of equivalents. Moreover, those having ordinary skill in the art will understand that reciting “a” element or “an” element in the appended claims does not restrict those claims to articles, apparatuses, systems, methods, or the like having only one of that element, even where other elements in the same claim or different claims are preceded by “at least one” or similar language. Similarly, it should be understood that the steps of any method claims need not necessarily be performed in the order in which they are recited, unless so required by the context of the claims. In addition, all references to one skilled in the art shall be understood to refer to one having ordinary skill in the art.

A denoxing plant can be made markedly smaller and less costly and can be operated in a manner that is more resource-efficient by a process as described at the outset where the first flue gas is generated in an external combustion chamber arranged outside the steam reformer and upstream of the steam reformer by combustion of a first fuel gas with air and, together with the second fuel gas, introduced into the firing units of the steam reformer for firing, wherein the first flue gas has a residual oxygen content sufficient for the firing.

This has the result that the flame temperatures both in the external combustion chamber and in the steam reformer are kept as low as possible by effecting maximum staging of the combustion.

In the external combustion chamber a high air excess contributes to cooling of the flame while the combustion in the reformer produces fewer nitrogen oxides due to the reduced oxygen content in the first flue gas. The first flue gas generated in the external combustion chamber by combustion of a first fuel gas with air comprises less than the regular 21% by volume of oxygen due to the pre-combustion and so the actual combustion of the second fuel gas together with the first flue gas for firing the firing units of the steam reformer in the reformer no longer occurs as rapidly and thus as hotly as without this combustion staging. This significantly reduces the formation of thermal nitrogen oxides. The observed reduction in the formation of thermal nitrogen oxides is in the range of more than 50% and so the use of a denoxing system can be avoided or the denoxing plant can be made markedly smaller and operated in a manner that is markedly more resource-efficient.

It is a further advantage of the process according to the disclosure that the combustion air is preheated for example upon startup or in the case of a cold ambient temperature, thus negating the risk of condensation in flue gas-heated combustion air preheaters for example. In addition, the steam reformer is heated to a uniform elevated temperature already prior to ignition of the first firing units.

In a development of the disclosure the second fuel gas and the first flue gas are introduced into the firing units of the steam reformer in a quantity ratio at which the residual oxygen content of the first flue gas is sufficient for complete combustion of the second fuel gas. This ensures efficient utilization of the energy content present in the second fuel gas and avoids incomplete combustion of the second fuel gas which would lead to the generation of a higher proportion of undesirable byproducts, for example carbon monoxide. In particular, introduction of further oxygen-containing gases into the firing units of the steam reformer may be dispensed with.

The residual oxygen content of the first flue gas preferably exceeds the stoichiometric ratio for complete combustion of the second fuel gas by 1% to 30%. A residual oxygen content that exceeds the stoichiometric ratio by more than 15% may be advantageous for example if a high flue gas stream is desired for thermal engineering reasons. For a further improvement of NOₓ reduction and complete combustion a residual oxygen content that exceeds the stoichiometric ratio by 5% to 15% is preferred. It has been found that an oxygen excess in this range makes it possible to reliably achieve complete combustion of the second fuel gas under the real-life conditions in the firing unit. A higher residual oxygen content in the combustion chambers of the firing units resulted in increased formation of nitrogen oxides. A residual oxygen content in this range therefore allows complete combustion coupled with low emission of nitrogen oxides.

The residual oxygen content in the first flue gas upon introduction into the firing units of the steam reformer is preferably in the range from 10% by volume to 19% by volume. Admixing of air before introduction of the first flue gas into the firing units is preferred if the residual oxygen content of the first flue gas upon exiting from the external combustion chamber is below this range. As a result of the reduced residual oxygen content relative to air the proportion of components exhibiting inert behaviour in the combustion in the firing units in the first flue gas increases. Consequently, the flame occupies a larger volume during the combustion of the second fuel gas, with the result that less thermal energy per unit volume is reduced. In addition, the inert components also absorb heat. Both effects have the result that the flame temperature and thus the production of nitrogen oxides is reduced. At a residual oxygen content below 10% by volume the required reaction volume in the firing units becomes large enough to result in additional difficulties in providing homogeneous reaction conditions. In addition, achieving such a low residual oxygen content would require intense heating in the pre-combustion which would itself result in an increase in nitrogen oxides.

In a development of this process according to the disclosure the temperature of the first flue gas is adjusted such that second fuel gas mixing with the first flue gas undergoes spontaneous combustion, i.e., without an ignition source. The autoignition brought about thereby makes the operation of a steam reforming plant considerably easier by omitting a costly and complex burner control means since personnel with portable igniters or permanently installed igniters on the typically present burners are no longer necessary to commence combustion in the reformer. This too helps the process according to the disclosure to contribute to a more economical operation of a steam reforming plant.

If the second fuel gas contains natural gas it is preferable when the temperature of the first flue gas is at least 700° C. upon introduction into the firing units. This makes it possible to reliably ensure autoignition of the second fuel gas.

In a preferred embodiment of the process according to the disclosure the thermal energy formed in the external combustion chamber arranged upstream of the steam reformer is utilized exclusively for preheating the first flue gas for the firing units of the steam reformer. In this context the combustion in the firing unit arranged outside the reformer is performed without thermal emission to other media. The sum of the first and the second fuel gas corresponds to the fuel gas amount that would be required in the case of sole firing in the reformer, as per the prior art, so that no additional fuel gas relative to the prior art need be used without having to forgo the advantages of the process according to the disclosure. Such a process mode is advantageous especially in the case of revamp solutions for existing plants since the overall mass and heat balance is not altered by the use of the upstream external combustion chamber.

In an alternative embodiment of the process according to the disclosure the thermal energy formed during combustion in the external combustion chamber arranged upstream of the steam reformer is at least partially withdrawn and decoupled from the first flue gas before introduction into the steam reformer. The combustion is thus carried out in the firing unit arranged outside the reformer with thermal emission to other media, thus further reducing the temperature of the first flue gas. As a result of this and the reduced oxygen content the formation of thermal nitrogen oxides in the reformer is still further reduced.

In a particularly preferred development of the process according to the disclosure the first flue gas generated in the combustion chamber arranged outside the reformer is admixed with air before introduction into the firing units. This opens the additional degree of freedom to adjust the ratio of combustion air to first fuel gas such that the formation of thermal nitrogen oxides in the external combustion chamber is further minimized and/or the dimensions of the combustion chamber can be reduced. In the case of the preheating of the combustion air this is limited to the portion that does not take part in the combustion in the external combustion chamber. The low temperature of the air proportion that takes part in the combustion in the external combustion chamber still further reduces the formation of thermal nitrogen oxides.

In a particularly simple variant of the process according to the disclosure, the steam reformer comprises a plurality of firing units and a common first flue gas stream from the external combustion chamber is used for all firing units. The common flue gas stream ensures that the combustion conditions in the firing units of identical construction are likewise identical. The restriction to a common flue gas stream further simplifies the control of the precombustion. In a development of the process according to the disclosure the plurality of firing units may be fed with the first flue gas via a common channel system, thus allowing the channel system to be made relatively simple.

In a variant of the process according to the disclosure the development in respect of minimizing the formation of thermal nitrogen oxides the combustion air is supplied to the external combustion chamber without any other preheating, with combustion of only a small amount of fuel gas occurring therein. The first flue gas from the external combustion chamber has a temperature of about 150° C. to 250° C. This may be the case when the combustion air is supplied to the external combustion chamber without any other preheating and the amount of first combustion gas is correspondingly small. The formation of thermal nitrogen oxides during combustion in the reformer combustion chamber is markedly reduced while this relatively low temperature of the first flue gas simultaneously allows for simple construction and material selection for the channel system that supplies the first flue gas to the firing units.

In a particularly energy-efficient development of the process according to the disclosure the heat generated during generation of the first flue gas is supplied to the steam reformer.

The disclosure further relates to a steam reforming plant for performing the process according to the disclosure.

To this end the steam reforming plant preferably comprises a steam reformer having one or more firing units, at least one external combustion chamber arranged upstream of the steam reformer for generating the first flue gas by combustion of the first fuel gas with air and a channel system by means of which the first flue gas is suppliable to the firing units.

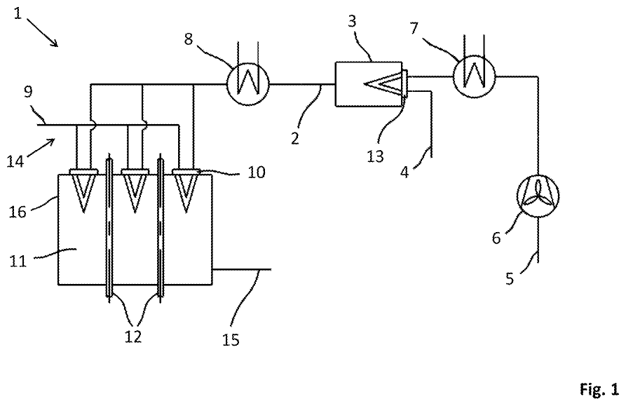

FIG. 1 is a schematic representation of a steam reforming plant 1 for performing the process according to the disclosure. In a first step a first flue gas 2 is generated in an external combustion chamber 3 arranged outside the steam reformer 16 and upstream of the steam reformer 16 by combustion of a first fuel gas 4 with air 5. However, it is also possible for two or more external combustion chambers for generating the first flue gas 2 to be provided. The external combustion chambers may be arranged in parallel and/or in series with one another. The air 5, in particular ambient air, is passed into the external combustion chamber 3 for example by a blower 6, wherein the temperature of the air 5 may be adjusted via an optional heat exchanger 7.

Subsequently, in a second step, once it has optionally been cooled or heated to adjust the temperature in an optional heat exchanger 8, the generated first flue gas 2 exiting the external combustion chamber 3 is introduced together with a second fuel gas 9 into the firing units 10 of the steam reformer 16 for firing. This keeps the flame temperature as low as possible since the overall combustion is very markedly staged due to the local separation into the external combustion chamber 3 and the reformer combustion chamber 11.

The first flue gas 2 generated in the external combustion chamber 3 by combustion of a first fuel gas 4 with air 5 thus comprises less than the regular 21% by volume of oxygen and so the actual combustion of the second fuel gas 9 together with the first flue gas 2 for firing the firing units of the steam reformer in the reformer no longer occurs as rapidly/hotly as without such a combustion staging.

In addition to at least one firing unit 10—also referred to as a reformer burner—each steam reformer 16 comprises a combustion chamber 11 made of refractory material and at least one reformer tube 12. The at least one reformer burner 10 is arranged for example at the top surface or the bottom surface of the combustion chamber 11 or else on the walls and fires the intermediate space between the reformer tubes 12. This heats the volume between the reformer tubes 12, thus heating the reformer tubes 12. The reformer tubes 12 in which the steam reforming reaction proceeds often contain catalysts to this end.

It is likewise apparent from FIG. 1 that a common first flue gas stream from the external combustion chamber 3 comprising a burner 13 is used for all reformer burners 10. The reformer burners 10 are fed with the first flue gas 2 via a common channel system 14, thus allowing the required channel system 14 to be made relatively simple. The flue gases from the combustion are discharged from the steam reformer 16 as a second flue gas 15.

### LIST OF REFERENCE NUMERALS

1 Steam reforming plant
2 First flue gas
3 External combustion chamber
4 First fuel gas
5 Air
6 Blower
7 Heat exchanger
8 Heat exchanger
9 Second fuel gas
10 Firing unit/reformer burner
11 Combustion chamber
12 Reformer tube
13 Burner
14 Channel system
15 Second flue gas
16 Steam reformers

1. A process for feeding firing units of a steam reformer with a second fuel gas and a first flue gas, wherein the first flue gas is generated in an external combustion chamber arranged outside the steam reformer and upstream of the steam reformer by combustion of a first fuel gas with air and, together with the second fuel gas, is introduced into the firing units of the steam reformer for firing, wherein the first flue gas has a residual oxygen content sufficient for the firing.

2. The process of claim 1, wherein the second fuel gas and the first flue gas are introduced into the firing units in a quantity ratio at which the residual oxygen content of the first flue gas is sufficient for complete combustion of the second fuel gas.

3. The process of claim 2, wherein the residual oxygen content of the first flue gas exceeds the stoichiometric ratio for complete combustion of the second fuel gas by 1% to 30%, preferably by 5% to 15%.

4. The process of claim 1, wherein the residual oxygen content in the first flue gas upon introduction into the firing units is in the range from 10% by volume to 19% by volume.

5. The process of claim 1, wherein the temperature of the first flue gas is adjusted such that second fuel gas mixing with the first flue gas undergoes spontaneous combustion.

6. The process of claim 1, wherein the second fuel gas contains natural gas and the temperature of the first flue gas is at least 700° C. upon introduction into the firing units.

7. The process of claim 1, wherein the thermal energy formed in the external combustion chamber arranged upstream of the steam reformer is utilized exclusively for preheating the first flue gas for the firing units of the steam reformer.

8. The process of claim 1, wherein the thermal energy formed during combustion in the external combustion chamber arranged upstream of the steam reformer is at least partially withdrawn and decoupled from the first flue gas before introduction into the steam reformer.

9. The process of claim 1, wherein first flue gas generated in the combustion chamber arranged outside the steam reformer is admixed with air before introduction into the firing units.

10. The process of claim 1, wherein steam reformer-comprises a plurality of firing units and a common first flue gas stream from the external combustion chamber is used for all firing units.

11. The process of claim 10, wherein the firing units are fed with the first flue gas via a common channel system.

12. The process of claim 1, wherein the first flue gas from the external combustion chamber has a temperature of about 150° C. to 250° C.

13. The process of claim 1, wherein the heat generated during generation of the first flue gas is supplied to the steam reformer.

14. A steam reforming plant for performing the process of claim 1.

15. The steam reforming plant of claim 14 further comprising: a steam reformer having one or more firing units, at least one external combustion chamber arranged upstream of the steam reformer for generating the first flue gas by combustion of the first fuel gas with air and a channel system by means of which the first flue gas is suppliable to the firing units.
